(19) United States
(12) Patent Application Publication
(10) Pub. No.: US 2004/0143447 A1
(43) Pub. Date: Jul. 22, 2004

(54) Determining the suitability of products to individuals

(76) Inventor: Winston James Lay, Newmarket (GB)

Correspondence Address: BARNES & THORNBURG, P.O. BOX 2786, CHICAGO, IL, 60690-2786, US

(21) Appl. No.: 10/626,385

(22) Filed: Jul. 23, 2003

(30) Foreign Application Priority Data
Jan. 21, 2003 (GB) 0302365.2

(51) Int. Cl. G06F 17/60

(52) U.S. Cl. 705/1

(57) ABSTRACT

Apparatus for determining the suitability of products, e.g. consumer products, to an individual comprises storage means storing first data (4) concerning the composition of the products and storage means storing second data (5) concerning the sensitivity of an individual to products or product ingredients, a scanner (1) for scanning markings representative of the products and processing means (3) for identifying a selected product from the scanned marking and providing an indication of the suitability of the identified product to the individual.

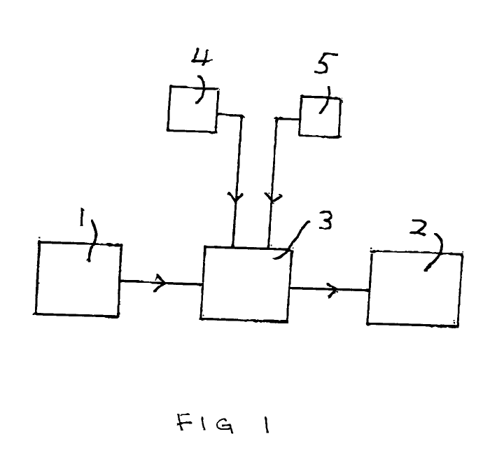

### FIELD OF THE INVENTION

This invention relates to determining the suitability of products, particularly but not exclusively consumer products, to individuals.

### BACKGROUND TO THE INVENTION

Consumer products are manufactured in bulk and offered for sale to consumers at large, but certain products are not suitable for use or consumption by everyone. For example, many individuals suffer an adverse reaction following ingestion of a particular foodstuff, dietary ingredient or additive, due to food intolerances or allergies Amongst such sensitivities are allergies to ordinary foodstuffs such as cows' milk or nuts, and allergies to food additives such as dyes, flavourings or preservatives. Also, some individuals are sensitive to certain medicines and pharmaceutical products. In addition, some individuals are sensitive to contact with or exposure to certain cosmetics or household products such as cleaning preparations, and also chemical raw materials and ingredients. Once an individual's particular sensitivity has been established, it is important to ensure that the individual is not exposed to any product unsuitable to that individual, and the invention aims to facilitate the monitoring or checking of products to determine their acceptability to individuals having pre-determined sensitivities.

Further, individual may wish for reasons of choice (e.g. for ethical or religious reasons) to avoid certain materials, such as animal products, genetically modified (GM) materials, cosmetics that have been tested on animals etc. Moreover, individuals may wish for reasons of personal choice (e.g. for personal preference or on medical grounds) to restrict their intake or exposure to certain materials, for instance restriction consumption of fat, sodium etc.

The present invention aims to assist individuals in screening and selecting products (including consumer products and raw materials) for suitability having regard to considerations such as those set out above.

### SUMMARY OF THE INVENTION

According to one aspect of the invention there is provided apparatus for determining the suitability of products to an individual, the apparatus comprising storage means storing first data concerning the composition of the products and storage means storing second data concerning the sensitivity of an individual to products or product ingredients, a scanner for scanning markings representative of the products and processing means for identifying a selected product from the scanned marking and providing an indication of the suitability of the identified product to the individual.

Normally, the first data will represent the composition or characteristic thereof of a range of products available to a user of the apparatus, either the complete composition or the composition of certain significant ingredients of the products, such as potentially allergic ingredients, fat or calorific values. The data is typically in relation to a unit amount of the product, eg 100 grams, a portion or dose etc. As noted above, the product may be a consumer product such as a foodstuff, medicine, pharmaceutical product, cosmetic, household product etc. A consumer may thus consider the suitability of such products prior to purchase or use. The product may also be a chemical raw material or ingredient: an individual may use the invention, for instance, to determine whether it is appropriate for that individual to handle or otherwise be exposed to such materials, e.g. in a warehouse. For example, the first data may include information concerning hazardous substances that can be used to assist compliance with relevant regulations, eg under COSHH (Control of Substances Hazardous to Health).

The second data may define products or product ingredients to which the individual is in some way sensitive as discussed above, e.g. allergic or intolerant or for reasons of choice.

Thus, where the product is taken internally such as a food or medicine the second data may relate to the individual's food intolerances, food allergies or food preferences, e.g. avoiding GM materials. Where the product is applied externally such as a cosmetic or medicament, the second data may e.g. relate to the individual's sensitivities to certain chemicals or the individual's preferences, e.g. avoiding products tested on animals. In all cases, the second data may be in the form of maximum values of product or product ingredients which are acceptable to the individual.

The apparatus may be in the form of a portable hand-held device incorporating the scanner, a computer providing the storage means for the first data at least and the processing means, and a display, eg a visual display, for indicating the acceptability of the product. A visual display could be replaced by or supplemented with an audible indication such as an alarm.

As an alternative to the apparatus being in the form of a single hand-held portable device, it is possible for the integers of the apparatus to be in separate devices, for example the storage means for the first data at least may be in a computer separate from a hand-held device incorporating the scanner. As a further possibility, the second data may be stored on a card such as a loyalty card.

The user of the apparatus may be the individual whose suitability to the products is stored in the storage means, but it is possible for the user of the apparatus to determine the suitability of the products for another individual, for example where the user is a carer and the individual is young, old or infirm.

The scanner may be operative to read a marking in the form of a machine-readable bar code which may be on the product itself or may be on a separate product label or product indicator. Thus, the form of marking will in most cases be chosen to suit the nature of the product but a machine-readable bar code is likely to be the most convenient form of marking for a packaged consumer product such as a foodstuff, cosmetic or medicament.

The user can then determine the suitability of a product by scanning the bar code in the home or in a store, preferably before purchase but in any event before use.

According to another aspect of the invention there is provided a method of determining the suitability of a product to an individual, the method comprising storing in computer means information concerning the composition of a plurality of products and information concerning the sensitivity of the individual to a product or product ingredient, scanning a marking representative of a selected product and thereby identifying the selected product and deriving an indication of the suitability of the selected product to the individual

### DETAILED DESCRIPTION

Apparatus forming a typical embodiment of the invention will now be described, by way of example, with reference to the accompanying drawing which shows the functional components of the apparatus in block diagram form. The apparatus is in the form of a portable hand-held device similar in size and shape to a mobile telephone. On its underside, the device has a scanner and on its upper surface the device has a display panel and a keypad with control keys including an on/off key. The device is powered by a rechargeable battery.

In the accompanying drawing the scanner and the display panel are shown by the reference numerals 1 and 2, respectively. Data from the scanner 1 is fed to a central processing unit 3 to which is also fed data from a first data store 4 and a second data store 5. Prior to use of the apparatus, the store 4 is fed with first data representing the composition of a plurality of consumer products, in this case food items which can be purchased from a supermarket. The store 5 is fed with second data concerning the sensitivity of an individual to food products and ingredients thereof, eg representing food allergies of the individual.

In use, the individual passes the scanner 1 across the bar code of a consumer product stocked by the supermarket. This may be done in the supermarket prior to purchase of the product or may be done after purchase, for example in the individual's home. The scanned information is fed to the central processing unit 3 which, by reference to the data in the store 4, identifies the product and is then able to compare the composition of the product with the data in the store 5 to provide, on the display panel 2, a visual indication as to whether the product is suitable for consumption by the individual. The display 2 may simply list the ingredients of the scanned product which are sensitive to the individual to enable the user to make a judgement as to the suitability of the product, or the divice may go further and provide a visual warning if the product is unsuitable for the individual, for example because the product exceeds levels of tolerance determined for the individual and pre-loaded into the store 5.

The data in the store 4 is updated to include information relating to products which are newly available or modified.

The device may include a printer to provide a hard copy of the displayed information, or the device may have the facility to be connected to a remote printer for the same purpose.

1. Apparatus for determining the suitability of products to an individual, the apparatus comprising storage means storing first data concerning the composition of the products and storage means storing second data concerning the sensitivity of an individual to products or product ingredients, a scanner for scanning markings representative of the products and processing means for identifying a selected product from the scanned marking and providing an indication of the suitability of the identified product to the individual.

2. Apparatus according to claim 1, wherein the first data represents the composition or characteristics thereof of a range of products available to a user of the apparatus.

3. Apparatus according to claim 1 wherein the second data defines products or product ingredients to which the individual is sensitive.

4. Apparatus according to claim 3, wherein, the second data is in the form of maximum values of product or product ingredients which are acceptable to the individual.

5. Apparatus according to claim 1, comprising a portable hand-held device incorporating the scanner, a computer providing the storage means for the first data at least and the processing means, and a display for indicating the acceptability of the product.

6. Apparatus according to claim 1, wherein the integers of the apparatus are in separate devices, with the storage means for the first data at least in a computer separate from a hand-held device incorporating the scanner.

7. Apparatus according to claim 1, wherein the second data is stored on a card.

8. Apparatus according to claim 1, wherein the scanner is operative to read a marking in the form of a machine-readable bar code on the product itself or on a separate product label or product indicator.

9. A method of determining the suitability of a product to an individual, the method comprising storing in computer means information concerning the composition of a plurality of products and information concerning the sensitivity of the individual to a product or product ingredient, scanning a marking representative of a selected product and thereby identifying the selected product and deriving an indication of the suitability of the selected product to the individual.
